(19) United States
(12) Patent Application Publication
(10) Pub. No.: US 2010/0321437 A1
(43) Pub. Date: Dec. 23, 2010

(54) METHOD FOR CORRECTING UNEVENNESS IN DENSITY FOR IMAGE RECORDING APPARATUS

(75) Inventor: Takeo OGAMA, Hachioji-shi (JP)

Correspondence Address: HOLTZ, HOLTZ, GOODMAN & CHICK PC, 220 Fifth Avenue, 16TH Floor, NEW YORK, NY, 10001-7708, US

(73) Assignee: Olympus Corporation, Tokyo (JP)

(21) Appl. No.: 12/819,439

(22) Filed: Jun. 21, 2010

(30) Foreign Application Priority Data
Jun. 22, 2009 (JP) 2009-147890

(51) Int. Cl. B41J 29/38

(52) U.S. Cl. 347/14

(57) ABSTRACT

Disclosed is a method for correcting unevenness in density. An image density and presence or absence of a miss fire of ink is detected from an inspection pattern recorded by an image recording apparatus. Density information of a nozzle causing a miss fire of ink is substituted with density information of a nozzle existing in the periphery of the nozzle causing a miss fire of ink.

### CROSS-REFERENCE TO RELATED APPLICATIONS

This application is based upon and claims the benefit of priority from prior Japanese Patent Application No. 2009-147890, filed Jun. 22, 2009, the entire contents of which are incorporated herein by reference.

### BACKGROUND OF THE INVENTION

1. Field of the Invention

The present invention relates to a method for correcting unevenness in density, for an image recording apparatus which records images by discharging ink onto recording media.

2. Description of the Related Art

In general, line head printers and page printers are commonly known as image recording apparatuses comprising a recording head which records images by discharging ink drops from nozzles. Such a recording head comprises rows each consisting of plural nozzles. The recording head is fixed to a holder member in a manner that the rows of nozzles coincide with width directions of recording paper sheets as recording media. When recording an image, a recording medium is moved so as to pass in front of the recording head by a conveyor mechanism. As the recording medium passes in front of the nozzles, ink drops are discharged.

Line head printers have an effective feature that no recording head need be moved but image recording at a high speed is achieved by increasing speeds of conveying recording media, in comparison with serial head printers in which a recording head is moved for scanning. On the other side, in line head printers, white bandings extending in a conveying direction are formed on a recording medium when one of the rows of nozzles causes discharge of no ink drops. Such a phenomenon of discharge of no ink drops is called miss fire (MF). MF is classified into two types, i.e., permanent MF and random MF. In the permanent MF, discharge of ink from a specific nozzle is continuously stopped even after a maintenance processing (such as wiping or flushing) is carried out. In the random MF, an unspecific nozzle accidentally causes discharge of no ink, and a proper discharge state can be recovered by a maintenance service or after a constant time period or after printing of a predetermined volume.

Though not as adverse as discharge of no ink, a foreign substance sticks to near nozzles and may cause ink to discharge in an oblique direction different from an ink emitting direction in normal operation. This is called a miss direction (MD). MD is also classified into two type, i.e., permanent MD which cannot be recovered by a maintenance processing, and random MD which accidentally occurs. A recording head causing the permanent MD cannot be repaired by a simple repair service. Therefore, a manufacturer or repairer conducts a service of replacing the recording head causing permanent MD with a proper recording head.

Also in inkjet printers, for example, there a case that all nozzles cannot have an equal diameter or holes of nozzles cannot be oriented in an equal direction due to manufacturing errors. This gives rise to situations that a discharged amount of ink varies for every nozzle and an angle of discharging ink also varies for every nozzle. These situations cause variants in density of ink colors in recorded images, i.e., unevenness in density. As a solution to cope with these situation, for example, Jpn. Pat. Appln. KOKAI Publication No. 2-054676 proposes a technique of changing a weight coefficient for each nozzle, to correct unevenness in density. In the publication, an inspection pattern for obtaining density unevenness information is recorded as an image on a recording medium in order to change the weight coefficient.

If a nozzle causing the aforementioned MF or MD exists when the inspection pattern is formed, the nozzle is regarded as forming extremely low ink color density. A correction coefficient of a greater value is applied to the nozzle than to other nozzles. For a nozzle causing the permanent MD, an area where an ink drop reaches is made greater than that for each of other nozzles, by a correction made with the correction coefficient of the greater value. Accordingly, unevenness in density can be corrected. On the contrary, application of such a greater correction coefficient to the nozzle does not effectively function for a nozzle causing the permanent MF. Alternatively, for a nozzle causing the random MF, the nozzle can recover a proper discharge state from a non-discharge state, and thereafter, unevenness in density is corrected by using such a greater correction coefficient. Then, an amount of ink discharged from the nozzle is greater than that from each of the other nozzles, and density is inversely increased too much. Therefore, when the inspection pattern for obtaining density unevenness information is analyzed, a nozzle causing MF or MD need be treated, distinguished from nozzles maintaining a proper discharge state. Jpn. Pat. Appln. KOKAI Publication No. 2008-254274 proposes a technique for determining MF to be abnormal by providing a determination threshold for the correction coefficient value.

As described above, an error in a recording head including a nozzle causing the MF is coped with by replacement. Whether occurring MF is permanent or random MF is determined by checking that occurring MF stops as a result of continuously and repeatedly performing an image recording processing a preset number of times, or by checking that occurring MF stops after repeatedly performing a maintenance processing a predetermined number of times. In production of products, recording heads assembled in image forming apparatuses are replaced with properly workable recording heads by an inspection as described above.

In actual, even after a malfunctioning recording head causing permanent MF is replaced with a proper one, there is a possibility that random MF occurs when an inspection pattern for correcting unevenness in density is recorded. Further, even if a maintenance processing is executed once on a nozzles, random MF may occur in other nozzles when an inspection pattern is recorded thereafter. In this respect, if a maintenance processing and recording of an inspection pattern are repeated a number of times until no random MF occurs any more, there is a risk that a very long time is required for a process of correcting unevenness in density and production costs increase.

### BRIEF SUMMARY OF THE INVENTION

According to an aspect of embodiments, there is provided a method for correcting unevenness in density for an image recording apparatus, comprising: recording discharging ink to a recording medium from a group of nozzles sequentially provided in a recording head, to record an inspection pattern for detecting an image density and presence or absence of a miss fire of ink; reading the inspection pattern recorded in the recording; detecting a portion where an image density is lower than a predetermined value, based on image information of the inspection pattern read in the reading, and of determining whether the portion where the image density is lower than the predetermined value is due to a miss fire of ink; selecting substitution candidate portion other than the portion where the image density is lower, from the image information of the inspection pattern, if the portion where the image density is lower is determined to be due to a miss fire of ink in the detecting; and substituting density information of the substitution candidate portion for density information of the portion where the image density is lower, wherein a density unevenness correction is performed, based on the substituted density information.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a system configuration of an image recording apparatus according to an inkjet scheme for practicing a method for correcting unevenness in density according to the first embodiment;

FIG. 2 is a view showing a conceptual configuration of an image recording section and a conveyor mechanism;

FIG. 3A is a view showing an example of an injection pattern for obtaining density unevenness information;

FIG. 3B also is a view showing an example of an injection pattern for obtaining density unevenness information;

FIG. 4 is a flowchart for describing the method for correcting unevenness in density for an image recording apparatus, according to the first embodiment;

FIG. 5 is a flowchart for describing a sub-routine for obtaining density information;

FIG. 6 is a flowchart for describing a sub-routine for calculating density unevenness correction coefficients;

FIG. 7 is a graph schematically representing a density for a corresponding nozzle after correction, which is expected from density unevenness correction, and an average density;

FIG. 8A is a graph schematically representing density unevenness correction coefficients before normalizing density unevenness correction coefficients;

FIG. 8B is a graph schematically representing density unevenness correction coefficients after normalizing density unevenness correction coefficients;

FIG. 9 is a flowchart for describing a method for correcting unevenness in density for an image recording apparatus, according to the second embodiment;

FIG. 10 is a flowchart for describing a method for correcting unevenness in density for an image recording apparatus, according to the third embodiment; and

FIG. 11 schematically represents total two second next nozzles in two sides of a nozzle causing MF, which are substitution candidate portions for the nozzle causing MF.

### DETAILED DESCRIPTION OF THE INVENTION

Hereinafter, embodiments of the present invention will be described below in detail with reference to the drawings.

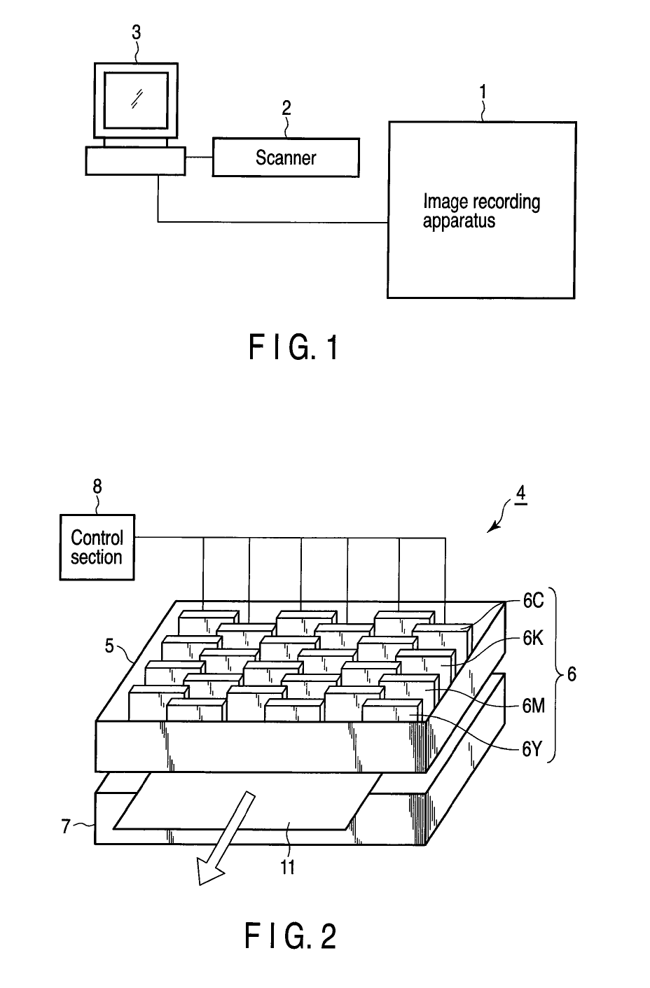

Described below will be a method for correcting unevenness in density for an image recording apparatus according to the first embodiment. FIG. 1 illustrates a system configuration of an image recording apparatus of an inkjet scheme for practicing the method for correcting unevenness in density according to the first embodiment. FIG. 2 illustrates a conceptual configuration of an image recording section and a conveyor mechanism. The configurations of the image recording apparatus in FIG. 1 and FIG. 2 represent only constitutive portions concerning the subject matter of the invention. Though not illustrated, common constitutive portions, such as a feed section for feeding recording media, an ink supply section, a container section for containing recording media, and a maintenance processing section, are comprised in the configurations.

The present embodiment comprises an image recording apparatus 1, a computer 3 connected to the image recording apparatus 1, and a scanner 2 connected to the computer 3. The image recording apparatus 1 in FIG. 2 is illustrated as a conceptual configuration of the image recording section 4 and the conveyor mechanism 7 according to the inkjet scheme.

The image recording section 4 comprises plural recording heads 6 each comprising at least one row of nozzles, and a head holder member 5 which holds the plural recording heads 6 which are arranged in rows for each of ink colors. The image recording section 4 is provided to be opposed to the conveyor mechanism 7 which conveys recording media 11.

The recording head 6 according to the present embodiment is configured to deal with ink of four colors, and comprises ink recording heads 6C which discharges cyan (C) ink, ink recording heads 6K which discharges black (K) ink, ink recording heads 6M which discharges magenta (M) ink, and ink recording heads 6Y which discharges yellow (Y) ink. The ink recording heads are arranged in this order from an upstream side in a conveying direction.

The recording heads are arranged in the order of recording heads 6C, 6K, 6M, and 6Y from the upstream side in the conveying direction of the conveyor mechanism 7. The present embodiment uses six short recording heads for each ink color. The short recording heads 6 for each ink color are arranged alternately in two rows in a direction perpendicular to the conveying direction, over a total length equal to or longer than the width of the recording medium 11. Ends of each of the short recording heads 6 are arranged so as to overlap ends of other ones of the short recording heads 6 so that no gap may be formed between rows of nozzles where the nozzles are viewed in the conveying direction. The recording heads 6 each are, for example, an actuator constituted by a piezoelectric element, and is driven to discharge ink through nozzles under control of the control section.

Next, a procedure for correcting unevenness in density in the image recording apparatus 1 will be described with reference to the system for correcting unevenness in density, as illustrated in FIG. 1.

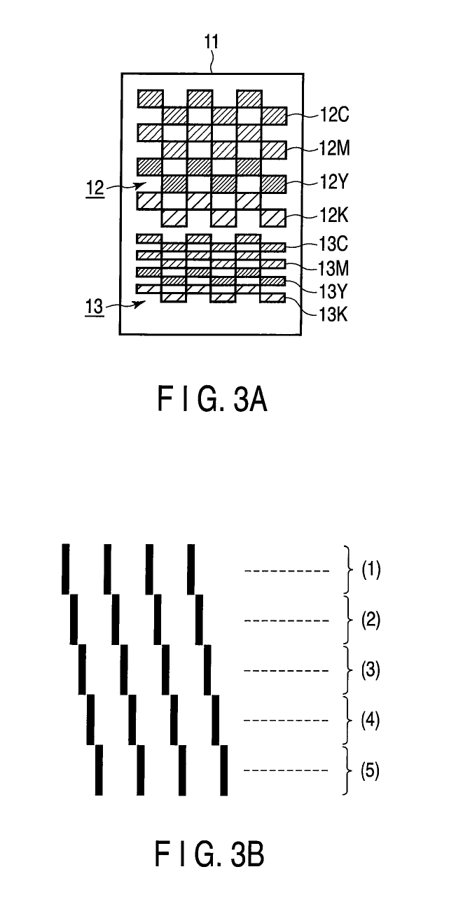

Firstly, the conveyor mechanism 7 conveys a recording medium 11 received from an unillustrated media feed section so as to pass in front of the recording heads 6. At this time, in accordance with an instruction from the control section, ink is discharged to the recording medium 11, to record an inspection pattern for obtaining density unevenness information. This inspection pattern is a pattern illustrated as an example in FIG. 3A and includes a solid pattern 12 and a nozzle check pattern 13.

Of these patterns, the solid pattern 12 consists of C solid patterns 12C, M solid patterns 12M, Y solid patterns 12Y, and K solid patterns 12K, which are arranged alternately so as not to overlap each other on the recording medium.

The nozzle checker pattern 13 consists of C nozzle check patterns 13C, M nozzle check patterns 13M, Y nozzle check patterns 13Y, and K nozzle check patterns 13K. The nozzle check pattern 13 is recorded following the solid pattern 12, and the nozzle check patterns 13C, 13M, 13Y, and 13K are arranged alternately so as not to overlap each other.

Also, the nozzle check pattern 13 records, for example, a line segment pattern (1) of line segments having a preset length, by discharging ink from plural nozzles at constant intervals. Next, a line segment pattern (2) is recorded by using plural nozzles respectively next to the plural nozzles used for recording the line segment pattern (1). Subsequently, line segment patterns (3) to (5) are recorded while orderly switching nozzles to be used for recording. As a result, a stepped nozzle check pattern as illustrated in FIG. 3B is recorded in which ink is discharged sequentially from one after another of the nozzles.

The inspection pattern is read by the scanner 2, and image information thereof is sent to the computer 3. The computer 3 calculates a density unevenness correction coefficient for each nozzle of the recording heads 6, from received image information, and sets the coefficients in an unillustrated parameter table in the image recording apparatus 1. The control section 8 generates density unevenness correction data based on the set density unevenness correction coefficients, and drives each nozzle of the recording heads 6. Here, the density unevenness correction coefficients are, for example, weight coefficients for error diffusion.

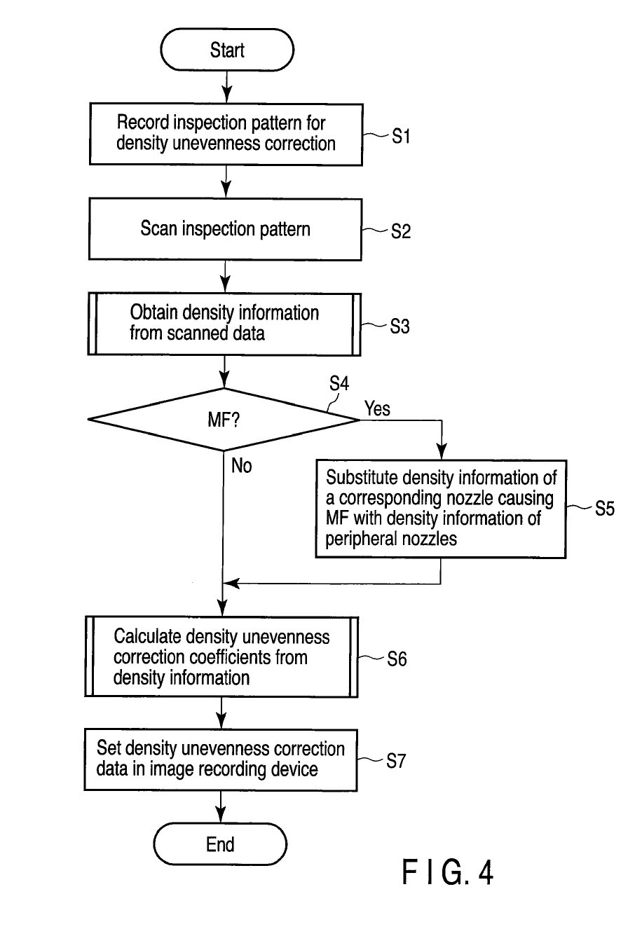

Next, the method for correcting unevenness in density according to the image recording apparatus system configured as described above will be described, referring to a flowchart drawn in FIG. 4.

In the method for correcting unevenness in density according to the present embodiment, an inspection pattern for obtaining density unevenness information is recorded on a recording medium 11 (step S1), and thereafter, the inspection pattern is scanned and obtained as scanned data [image information] (step S2).

Next, the scanned data is analyzed to obtain density information (step S3). When the scanned data is analyzed, whether an interested nozzle causes a miss fire (MF) or not is determined (step S4). If an interested nozzle is determined to cause MF by the determination (YES), density information of the nozzle is replaced with density information obtained from peripheral substitution candidate portions of the nozzle causing MF (step S5).

Next, if the interested nozzle is not determined to cause MF in step S4 (NO) after substitution with the density information of the peripheral substitution candidate portions, a density unevenness correction coefficient for the interested nozzle is calculated from the obtained density information (step S6). Further, the calculated density unevenness correction coefficient is set in the image recording apparatus 1 (step S7), and a series of correction processing is then ended.

Procedures in the steps in the flowchart described above will now be described in more details.

In steps S1 and S2, the inspection patterns 12 and 13 recorded on the recording medium 11 is read by the scanner 3. At this time, a scan resolution is preferably equal to or greater than an image recording resolution of the image recording apparatus 1, and a color mode, if available, is RGB.

The scanned data (image information) obtained as a result of scanning is not subjected to irreversible compression. For example, a format used for saving image files is TIFF.

Referring to a flowchart drawn in FIG. 5, a description will now be made of a sub-routine in step S3 for obtaining density information.

If density information is obtained from scanned data in step S3 described above, for example, a TIFF image in the RGB mode is read (step S3-1). Next, ends of each of areas of the image which are respectively recorded by the recording heads 6 are detected, and the read image is associated with density information obtaining positions of the recording heads 6 (step S3-2). Further, when solid recorded parts of C ink are read, a R channel is referred to. When solid recorded parts of M ink are read, a G channel is referred to. When solid recorded parts of Y ink are read, a B channel is referred to. When solid recorded parts of K ink are read, a G channel is referred to. Further, RGB values at pixels corresponding to the respective nozzles are averaged in the conveying direction of the recording medium 11, thereby to obtain density information (step S3-3). The processing flow then returns.

Further, the determination in step S4 is made on a read result of reading the inspection pattern illustrated in FIG. 3B for checking nozzles.

This determination is made depending on whether line segments are recorded at positions respectively corresponding to the nozzles or not. If a corresponding line segment exists at a position corresponding to one of the nozzles, the nozzle is determined to cause no MF. If nothing is recorded at the position, the nozzle is determined to cause MF.

In the present embodiment, the line segments are recorded by discharging ink from the nozzles in an order of locations of the nozzles. Therefore, for each line segment, ink drops need not be dropped just below an interested nozzle. That is, whether MF occurs or not can be determined depending on presence or absence of a line segment. That is, even when a position of a line segment varies more or less due to MD, an accurate determination can be made.

In next step S5, density information corresponding to a nozzle determined to cause MF is replaced with density information of substitution candidate portions corresponding to nozzles in the periphery of the nozzle.

In the present embodiment, the nozzles in the periphery of an interested nozzle are set to be, for example, total two nozzles which are second next to the interested nozzle in two sides of the interested nozzle as a center (FIG. 11). Of course, this setting is an example, and the nozzles in the periphery of an interested nozzle are not limited to two second next nozzles respectively in two sides of the interested nozzle. Further, phrasing of substitution with density information of peripheral nozzles at substitution candidate portions implies, for example, that an average value of density information at two substitution candidate portions corresponding to the two nozzles are deal with as density information of the interested nozzle causing MF. If the inspection pattern is associated with substitution candidate portions for nozzles, a position of white data obtained where a nozzle drops no ink may be determined to be a position of a nozzle causing MF.

According to the setting of density information as described above, density information of a nozzle causing MF is overwritten with density information based on two second next nozzles (an average value of density information between the two second next nozzles) even when density information directly obtained from the nozzle causing MF is zero or a very small value (as calculated from a light color).

Unevenness in density which is specific to the recording heads 6 is due to, for example, variants of diameters of nozzle holes or operational variants of actuators which exist when nozzle holes are processed in process of manufacturing nozzle plates. In this case, discharge characteristics which cause unevenness in density are substantially constant for each nozzle. Further, discharge characteristics of nozzles adjacent to a nozzle are similar in many cases. Therefore, there is no problem in taking an average density between two second next nozzles in two sides, as density information of a nozzle causing MF.

Here, density information of two nozzles directly next to the nozzle causing MF in two sides may possibly have been lightened under influence of MF, and is therefore not used as substitution candidate portion. If the inspection pattern has been scanned at a sufficiently high resolution relative to an image recording resolution (a printing resolution) of the recording head 6, density information of any nozzle can be referred to insofar as the nozzle is distant by a distance equivalent to two nozzles from a nozzle causing MF and is within a sufficiently shorter range than a fluctuation cycle of unevenness in density.

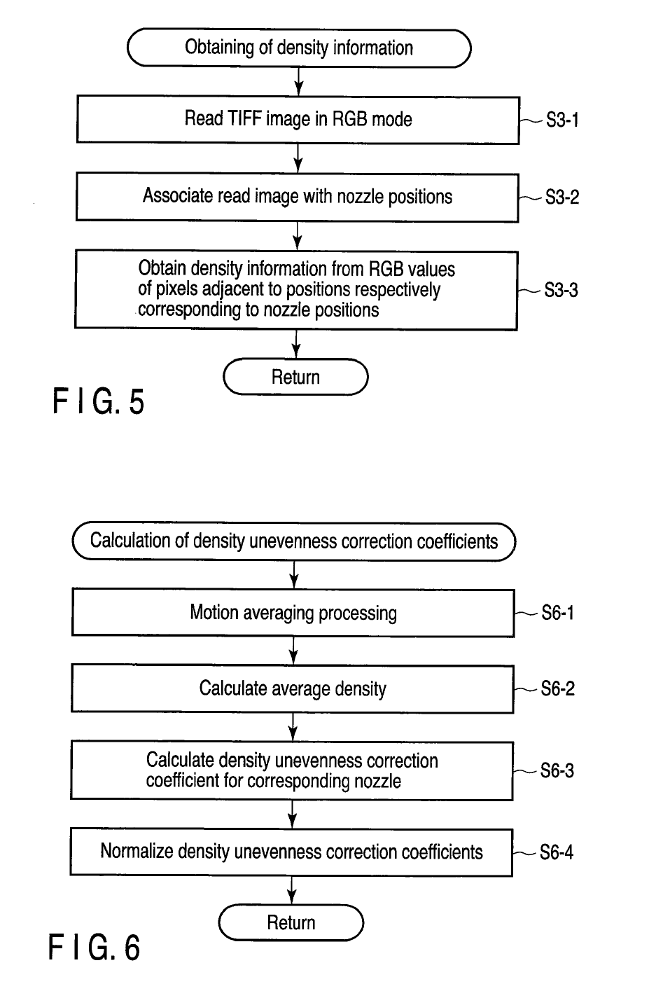

Referring to the flowchart in FIG. 6, the sub-routine for calculating density unevenness correction coefficients in step S6 will now be described. In a procedure of step S6, a density unevenness correction coefficient is calculated for each nozzle, based on density information of each nozzle, which has already been obtained.

At first, a motion averaging processing of reducing high-frequency noise from density information is performed (step S6-1). Further, for each interested nozzle, an average density is obtained within a range of ±M nozzles from the interested nozzle as a center (step S6-2). From density information of this average density for the interested nozzle, a density unevenness correction coefficient is calculated for the nozzle (step S6-3). Next, density unevenness correction coefficients for all the nozzles in the recording heads 6 are normalized by a maximum value of recording unevenness correction coefficients for all the nozzles (step S6-4). The processing flow then returns.

A procedure as described above for calculating density unevenness correction coefficients will now be described in more details.

In step S6-1, density information for ±M nozzles from an interested nozzle as a center is averaged, thereby to suppress influence such as noise which has been mixed in scanned data during scanning in step S2. A processing to be performed at this time may be a different processing from the motion averaging processing, and may more preferably be a filtering processing for selectively suppressing only high-frequency noise.

In step S6-2, density information of all of ±M nozzles from an interested is averaged as a target for which a density unevenness correction coefficient is calculated. A number M determine a number of nozzles to be used for average calculation. A number M is determined based on ink and printing characteristics of the heads. The greater the number M is (for example, 300 or so for a head comprising 600 nozzles), the more uniform within a recording head 6 the density after correcting unevenness in density is.

Otherwise, if a small number M is taken (for example, 100 or so for a head comprising 600 nozzles), a density gradient remains after correcting unevenness in density. If the small number M is used in calculation, a density unevenness correction coefficient is comparatively close to “1”. A correction when the small number M is used does not function to make densities uniform throughout the whole of a recording head 6, and therefore, a great correction for unevenness in density is not performed for nozzles having a high density.

Usually, a density gradient not higher than a particular degree cannot be recognized by human eyes. A density gradient up to the particular degree can be therefore considered to remain in the recording head 6. Accordingly, a number M with which a least necessary correction is made to unevenness in density should preferably be preset. If a nozzle as a target for density unevenness correction is positioned at an end of a row of nozzles and if a range of ±M nozzles can therefore not be referred to, density information of 2×M nozzles from the nozzle at the end of the recording head is averaged and used for substitution.

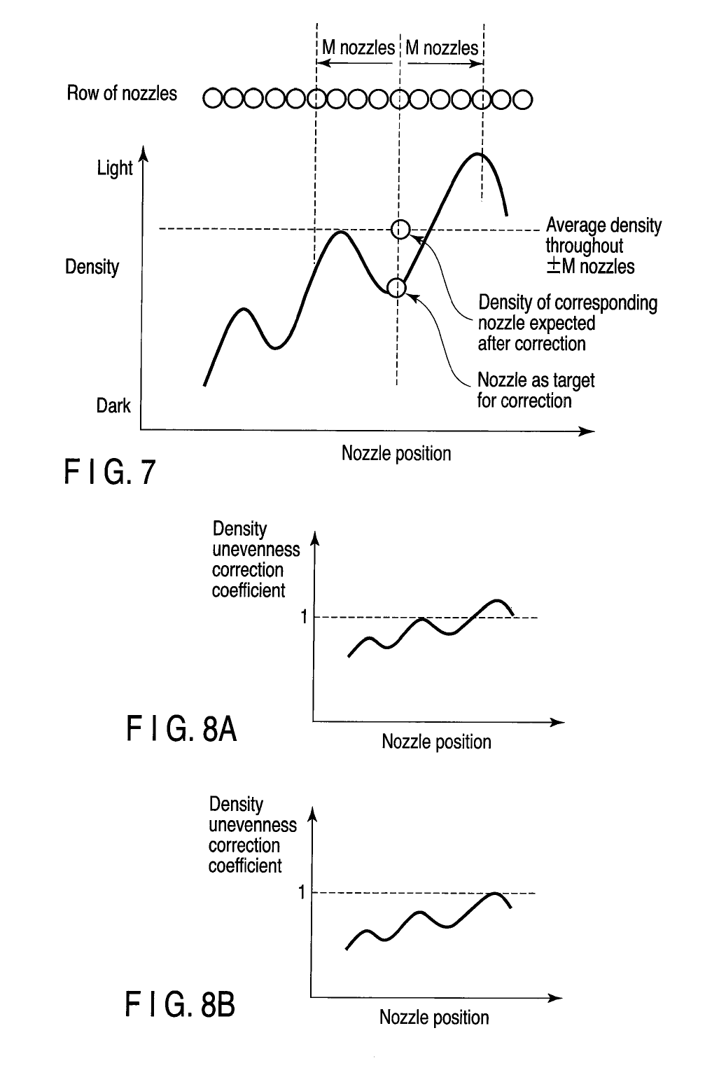

In step S6-3, a ratio of a density of the nozzle as a target for density unevenness correction to an average density obtained by step S6-2 is calculated and taken as a density unevenness correction coefficient. That is, a corrected density of the nozzle which is expected by the density unevenness correction is an average density of nozzles within a range of ±M nozzles from the nozzle, as represented in FIG. 7. For example, if a density of a nozzle as a target for density unevenness correction is light relative to an average density in the periphery of the nozzle, RGB values as density information of the nozzle are greater than those averaged in the periphery of the nozzle, and therefore, a correction coefficient for the nozzle is greater than “1”.

Otherwise, if a density of a nozzle as a target for density unevenness correction is dark relative to an average density in the periphery of the nozzle, RGB values as density information of the nozzle are smaller than those averaged in the periphery of the nozzle, and therefore, a correction coefficient for the nozzle is smaller than “1”.

In step S6-4, a maximum value of density unevenness correction coefficients concerning all nozzles which have been obtained in step S6-3 is calculated, and the density unevenness correction coefficients for all nozzles are normalized by using the maximum value. Through this normalization, density unevenness correction coefficients exceeding “1” as represented in FIG. 8A are changed to density unevenness correction coefficients having a maximum value of “1” as represented in FIG. 8B.

Next in step S7, density unevenness correction coefficients obtained in the foregoing step S6 are set in the image recording apparatus 1. After this setting, the image recording apparatus 1 causes the control section 8 to control the recording heads 6 to be driven by using error diffusion coefficients converted from the density unevenness correction coefficients.

As has been described above, the following is achieved by performing a density unevenness correction according to the present embodiment. That is, even if random MF occurs when the inspection pattern for obtaining density unevenness information is recorded, influence of the random MF can be excluded, and proper density unevenness correction coefficients can be calculated and set in the image recording apparatus 1. Similarly, even if random MF occurs, density unevenness correction coefficients excluding influence of the random MF are calculated and used. Therefore, neither a maintenance processing nor recording of the inspection pattern need be performed repeatedly until the random MF completely ceases, unlike in the prior art. In this manner, a time required for completing a density unevenness correction for the image recording apparatus 1 can be greatly reduced, and image recording can be achieved more efficiently in a shortened time period.

Next, a method for correcting unevenness in density for an image recording apparatus according to the second embodiment will be described.

In the first embodiment described above, a value obtained by averaging density information between two second next nozzles in two sides of a nozzle causing MF are taken as density information of the nozzle causing MF. In contrast, in the present embodiment, after a nozzle is determined to cause no MF, whether nozzles to be referred to for calculating density information discharge properly ink or not are determined. In this determination, if one or both of two second next nozzles in two sides of an interested nozzle causing MF are nozzles causing MF, density information of nozzles at more distant positions are used to improve accuracy of density unevenness correction coefficients set in the image recording apparatus 1, and thereby to reduce a risk of setting improper density unevenness correction coefficients.

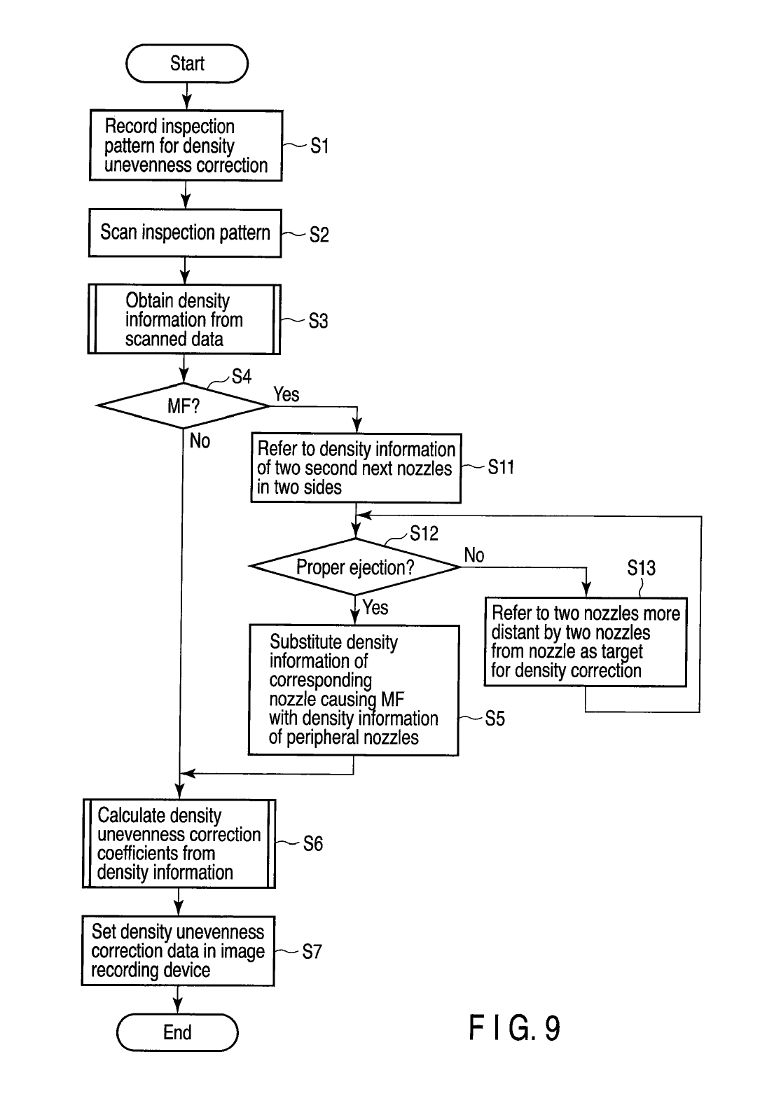

A method for correcting unevenness in density for an image recording apparatus system according to the present embodiment will be described, referring to a flowchart drawn in FIG. 9. In steps of the present embodiment, the same procedures as those in the first embodiment will be denoted at the same reference symbols, and detailed descriptions thereof will be omitted herefrom.

At first, in steps S1 to S3, an inspection pattern for obtaining density unevenness information of an image recorded on a recording medium 11 is obtained as scanned data. The scanned data is analyzed to obtain density information. Next, when the scanned data is analyzed, whether an interested nozzle causes MF or not is determined (step S4). If an interested nozzle is determined to cause MF by the determination (YES), density information of second next nozzles in two sides of the interested nozzle is referred to (step S11). Next, whether nozzles at positions referred to discharge properly ink or not is determined (step S12). In this determination, a further constant threshold is provided for density information used for the foregoing determination about presence or absence of MF. If a density is higher than the threshold, a corresponding nozzle is determined to be proper (YES). On the contrary, if a density is lower than the threshold, a corresponding nozzle is determined to be improper (NO).

In this determination, if proper (YES), density information of a corresponding nozzle is substituted with density information of nozzles at substitution candidate portions in the periphery of the nozzle causing MF (step S5). Otherwise, if a nozzle corresponding to a position to be referred to is determined to be improper (NO), density information of nozzles positioned distant by more two nozzles in a direction to be far away from the corresponding nozzle (namely, ±4-th next nozzles) is referred to (step S13). The processing then returns to step S12, and a determination is made again about presence or absence of MF. Thereafter, a density unevenness correction coefficient for the corresponding nozzle is calculated from the obtained density information (step S6). The calculated density unevenness correction coefficient is set in the image recording apparatus 1 (step S7). A series of correction processings is then ended.

According to the second embodiment as described above, density information is repeatedly obtained until density information of nozzles which properly emit ink is obtained if random MF occurs frequently when the inspection pattern for obtaining density unevenness information is recorded as an image and if second next nozzles to a nozzle causing MF as a target for density correction include a nozzle causing ME'.

Therefore, according to the method for correcting unevenness in density according to the present embodiment, density information of nozzles which properly discharge ink is obtained even if random MF occurs repeatedly when inspection data for obtaining density unevenness information is recorded as an image. Accordingly, a density unevenness correction can be performed properly without calculating an improper density unevenness correction coefficient under influence of random MF.

Described next will be a method for correcting unevenness in density for an image recording apparatus according to the third embodiment.

In the second embodiment described above, density information is obtained by repeatedly switching peripheral substitution candidate portions in units of two nozzles. However, if nozzles referred to, which properly discharge ink, are too distant from a nozzle causing MF as a target for density unevenness correction, there is a possibility that a difference exists to an actual density. Hence, the present embodiment limits a number of repetitions of referring to nozzles while switching nozzles to be referred to.

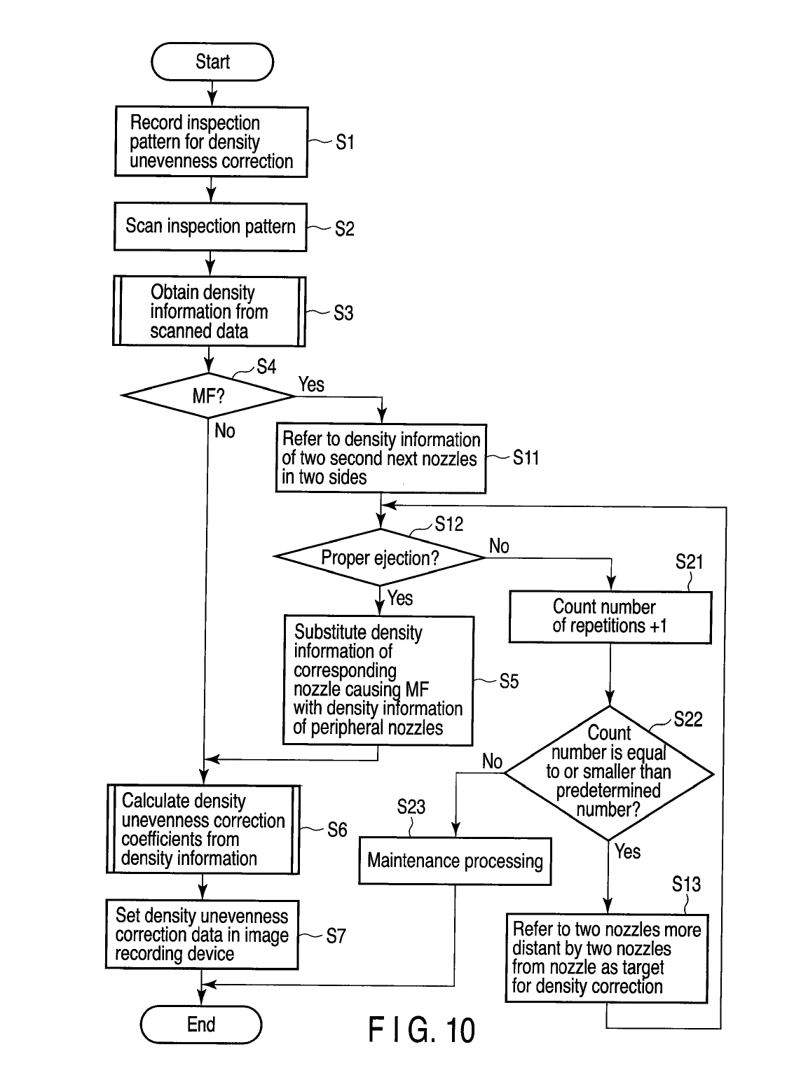

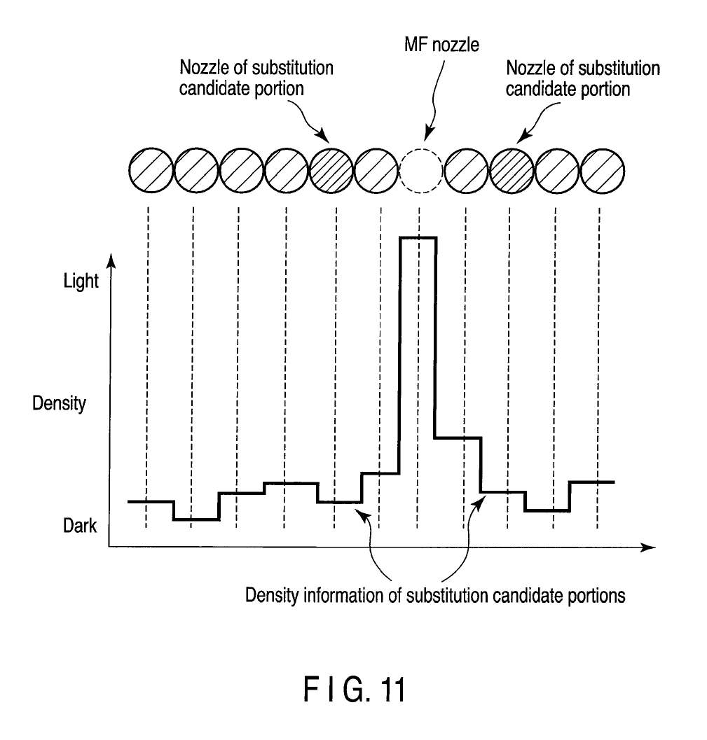

A method for correcting unevenness in density for an image recording apparatus system according to the present embodiment will be described below, referring to a flowchart drawn in FIG. 10. In steps of the present embodiment, the same procedures as those in the second embodiment will be denoted at the same reference symbols, and detailed descriptions thereof will be omitted herefrom.

At first, in steps S1 to S3, an inspection pattern which has been recorded as an image on a recording medium 11 is read, and density information is obtained therefrom by analysis. Next, in step S4 to S12, if an interested nozzle is analyzed as causing MF, density information of second next nozzles in two sides of the interested nozzle is referred to, and whether the second next nozzles properly discharge ink or not is determined.

In this determination, if properly (YES), density information of the interested nozzle is substituted with density information of nozzles at substitution candidate portions in the periphery of the interested nozzle (step S5). Otherwise, if the corresponding nozzles improperly discharge ink (NO), a count number (from an initial value of 0) indicating how many times a referring operation has been repeated is incremented by +1 (step S21). Whether the count number is equal to or smaller than an arbitrary preset value or not is determined (step S22). In this determination, if the count number is greater than the arbitrary preset value (NO), a nozzle maintenance processing is carried out (step S23), and a series of flow is ended. Otherwise, if the count number is equal to or smaller than the arbitrary preset value (YES), the flow returns again to step S12, and whether corresponding nozzles properly discharge ink or not is determined.

A density unevenness correction coefficient for a corresponding nozzle is calculated from the density information obtained or substituted in steps S4 and S5 (step S6). The calculated density unevenness correction coefficient is set in the image recording apparatus 1 (step S7). A series of correction processings is then ended.

In the present embodiment, the count number as a determination reference in the determination in step S22 is a value which is determined by a fluctuation cycle of unevenness in density specific to the recording head 6. That is, the shortest fluctuation cycle of unevenness in density is a range equivalent to K nozzles, the count number as the determination reference is set to be sufficiently smaller than K/2.

As has been described above, according to the method for correcting unevenness in density according to the present embodiment, recovery is tried by a maintenance processing if random MF occurs very often and if much labor is required to obtain density information of a nozzle as a target for density unevenness correction and density information of peripheral nozzles thereof. Further, if density information close to density information of a nozzle as a target for density unevenness correction is obtained in the periphery of the nozzle as a target for density unevenness correction, unevenness in density can be corrected by performing a density unevenness correction without a maintenance service or repetitive image recoding.

In configuration examples as described above in the foregoing first to third embodiments, the image recording apparatus 1, scanner 2 and computer 3 are connected to each other by cables. The embodiments are not limited to these examples but, for example, required information may be transferred by recording media, optical communications, or wireless communications (such as LAN). Further, the scanner 2 and computer 3 have been described as members which are separate from the image recording apparatus 1. However, the image recording apparatus 1 may comprise functions of the scanner 2 and computer 3.

In the foregoing examples, the inspection pattern for obtaining density information is configured to record, as an image, the solid pattern 12 and the nozzle check pattern 13 together. The embodiments are not limited to these examples but the inspection pattern may be constituted only of the solid pattern 12. When only the solid pattern 12 is used, an alternative method is available in which a nozzle causing MF is determined by providing a predetermined threshold for image information which is read by the scanner 2.

In the embodiments described above, when density information of a nozzle causing MF is calculated in the procedure of step S4 in the method for correcting unevenness in density, an average value between two second next nozzles in two sides of the nozzle causing MF is taken as density information of the nozzle causing MF. However, as a modification thereof, an averaged density throughout a range N (of, for example, 10 nozzles or so) from a nozzle causing MF to a specified nozzle except for the nozzle causing MF and next nozzles in two sides of the nozzle causing MF may be taken as density information at a substitution candidate portion for the nozzle causing MF. For example, an average value among 3-rd, 4-th, 5-th, and 6-th next nozzles in two sides of the nozzle causing MF may be taken as density information at a substitution candidate portion for the nozzle causing MF. Thus, influence of noise which is contained in data can be suppressed by averaging density information of plural nozzles at the time of scanning in the procedure in step S2. The range N of plural nozzles is determined according to characteristics of cycle of unevenness in density of the recording head 6. For example, if unevenness in density have a characteristic of varying at a constant cycle, the range N is a sufficiently small value relative to the fluctuation cycle of unevenness in density. Further, an average may be weighted in proportion to a distance from a nozzle causing MF to a nozzle for which density information is obtained.

As a usage of density correction coefficients, the control section 8 drives the recording heads 6, taking density unevenness correction coefficients as weight coefficients for error diffusion. The embodiments are not limited to this usage. For example, an alternative method is available in which, in process of converting original image data into data to be subjected to image recording by the image recording apparatus 1, density unevenness correction coefficients may be used to apply error diffusion to the image data itself.

As a method for determining density correction coefficients, a method for normalizing a maximum value of density correction coefficients to “1” has been described. However, this is merely an example. If a density unevenness correction is performed with use of density unevenness correction coefficients greater than “1”, values greater than “1” can be used included in density unevenness correction coefficients, in case of an image recording apparatus which can print a dot having a greater diameter than a dot diameter when a coefficient “1” is set. In this case, normalizing as described above need not be performed.

According to the embodiments of the invention, there is provided a method for correcting unevenness in density for an image recording apparatus, wherein a density unevenness correction is performed without repeating a maintenance processing or recording of an inspection pattern even when random MF occurs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for correcting unevenness in density for an image recording apparatus, comprising:
recording discharging ink to a recording medium from a group of nozzles sequentially provided in a recording head, to record an inspection pattern for detecting an image density and presence or absence of a miss fire of ink;
reading the inspection pattern recorded in the recording;
detecting a portion where an image density is lower than a predetermined value, based on image information of the inspection pattern read in the reading, and of determining whether the portion where the image density is lower than the predetermined value is due to a miss fire of ink;
selecting substitution candidate portion other than the portion where the image density is lower, from the image information of the inspection pattern, if the portion where the image density is lower is determined to be due to a miss fire of ink in the detecting; and
substituting density information of the substitution candidate portion for density information of the portion where the image density is lower, wherein
a density unevenness correction is performed, based on the substituted density information.

2. The method for correcting unevenness in density for an image recording apparatus, according to claim 1, wherein the selecting comprises checking whether the density information of the substitution candidate portion is proper or not.

3. The method for correcting unevenness in density for an image recording apparatus, according to claim 1, wherein in the selecting, an image corresponding to a nozzle which is distant by a distance equivalent to plural nozzles from the portion where the image density is lower is selected as the substitution candidate portion.

4. The method for correcting unevenness in density for an image recording apparatus, according to claim 3, wherein in the selecting, plural images corresponding to plural nozzles are selected as the substitution candidate portion, and the substituting calculate an average value of density information of the plural images corresponding to the plural nozzles and be used the average value for substitute.

5. The method for correcting unevenness in density for an image recording apparatus, according to claim 2, further comprising maintaining a maintenance service performs the recording head, wherein
in the maintaining, the maintenance service for the recording head is performed if the density information of the substitution candidate portion is determined to be not proper in the checking.

6. The method for correcting unevenness in density for an image recording apparatus, according to claim 2, further comprising
maintaining a maintenance service performs the recording head; and
detecting counting a number of times by which the check step is performed, and of determining whether the counted value exceeds a predetermined value or not, wherein
in the maintaining, the maintenance service for the recording head is performed if the counted value in the detecting exceeds the predetermined value.
